(19) United States
(12) Patent Application Publication
(10) Pub. No.: US 2002/0150308 A1
(43) Pub. Date: Oct. 17, 2002

(54) Image processing method, and an apparatus provided with an image processing function

(76) Inventor: Kenji Nakamura, Osaka (JP)

Correspondence Address: MCDERMOTT, WILL & EMERY, 600 13th Street, N.W., Washington, DC, 20005-3096, US

(21) Appl. No.: 10/104,977

(22) Filed: Mar. 25, 2002

(30) Foreign Application Priority Data
Mar. 29, 2001 (JP) 2001-97455

(51) Int. Cl. G06K 9/00

(52) U.S. Cl. 382/286; 382/181

(57) ABSTRACT

A distance image is formed by plotting a plurality of subject distances inputted from a distance measuring device of an image generator at distance measuring spots within a viewscreen. An area dividing processor divides the viewscreen into areas having the same distance ranges. A width calculator calculates a plurality of widths in horizontal direction for each divided area. A human figure discriminator calculates width ratios using a plurality of calculated widths for each divided area and judges the divided area to be an area corresponding to a human figure when at least one of the calculated width ratios falls within a specified range of a width ratio (head width/trunk width) human figures actually possess. Precision in judging a human figure is improved by judging the area using the width ratios human figures actually possess. Thus, the area corresponding to the human figure in the image can be precisely detected.

This application is based on patent application No. 2001-97455 filed in Japan, the contents of which are hereby incorporated by references.

### BACKGROUND OF THE INVENTION

This invention relates to an image processing method and an apparatus provided with an image processing function, in particular to an image-processing method having a human image detection for detecting a human in image included in an image.

In the technological field of cameras including cameras using silver-halide films, electronic still cameras and video cameras, there have been realized cameras in which a multi-area distance measuring device and a multi-area light measuring device are put to practical use, the position of a main subject or a human figure within a viewscreen is estimated using the subject distances from the camera to the subject and the subject brightness or amounts of light reflected by the subject that are measured at a plurality of points within the viewscreen, and focus and exposure are automatically adjusted to the main subject.

In the field of electronic still cameras, there have been proposed various methods for detecting a main subject within a viewscreen using a plurality of pieces of subject distance information obtained by a multi-area distance measuring device.

In photographing apparatuses such as electronic still cameras, video cameras and monitor cameras, it is desirable to reduce an error detection of a main subject to be controlled in executing an AF (Automatic Focusing) control, an AE (Automatic Exposure) control and a tracking control. Particularly in the case that a main subject is a human figure, it is desirable to maximally reduce error detection of a human figure within the viewscreen since this human figure is thought to be a subject a photographer intends to photograph and have a higher photographing value than a background and the like within the viewscreen.

For example, Japanese Unexamined Patent Publication No. 5-196858 discloses a method for preferentially detecting a subject closest to a camera as a main subject based on subject distances, wherein an area in the viewscreen taken up by the main subject is extracted by extracting the subject distances presumed to be of the same main subject from a plurality of subject distances obtained by a multi-area distance measuring device, and whether or not the extracted area is a human image is detected using subject brightness data obtained by a multi-area light measuring device and corresponding to this area. This method can have a better precision in detecting a human figure as a main subject than a method for detecting a main subject only based on a subject distance by using a combination of the subject distance information and the subject brightness information.

Since the known method disclosed in the Publication No. 5-196858 is adapted to detect the human figure within the viewscreen by combining the subject distance and the subject brightness, it has a better precision in detecting the human figure than the method for detecting the human figure only based on the subject distance. However, the subject included within the viewscreen is not necessarily a human figure, the subject distance of the human figure as the main subject is arbitrary and the human figure is not necessarily always closest to the camera. Thus, the precision of this method in detecting the human figure is not necessarily sufficient.

Specifically, according to the method disclosed in the Publication No. 5-196858, the human main subject is specified based on the subject brightnesses from a plurality of main subject candidates close to the camera and extracted based on the subject distances. Thus, there is a possibility of erroneously detecting a nonhuman main subject candidate having a brightness similar to a human as the human main subject.

Further, Japanese Unexamined Patent Publication No. 6-214148 discloses a method according to which a light detecting area of a distance sensor is divided into a plurality of areas, a subject distance is detected for each divided area, a range of the divided area where the subject distance of the same subject was detected is calculated and a size of the subject defined by a product of this range and the subject distance is calculated in a passive distance measuring device, and a main subject is specified based on the size of this subject. This method can have a better precision in detecting the main subject than a method for detecting a main subject only based on a subject distance by specifying the main subject based on the size of the subject defined by the product of the width of the subject light image on the viewscreen and the subject distance.

Since the size of the subject is defined by the width of one subject and the subject distance according to the method disclosed in the Publication No. 6-214148, there is a possibility of an error detection in the case that a nonhuman image having substantially the same size as the subject presumed to be a human figure is included within the viewscreen. Further, the size of the human figure differs depending on whether he/she is an adult or a child and the size of the subject light image within the viewscreen differs even if the subject distance is same. Therefore, children and the like may not be detected as human figures and it is difficult to securely detect the human figure regardless of whether or not it is an adult or a child while distinguishing it from other subjects.

Further in the field of video cameras, there have been proposed various methods for detecting a human figure within a viewscreen using a color information of each frame image. For example, U.S. Pat. No. 6,072,526 discloses a method for detecting a human figure within a viewscreen by extracting a skin-color section from each frame image and judging whether or not the skin-color section is a human image.

Since the skin color is a factor for distinguishing the human figure from other subjects according to the method disclosed in U.S. Pat. No. 6,072,526, there is a possibility of an error detection unless the color of the photographed image is accurate. Further, the skin color differs from person to person depending on gender, race, and whether or not the human figure is an adult or a child. Thus, the above detection may become an error due to these factors. Further, since the color information of the photographed image is easily influenced by a light source and an ambient light, the skin-color area may not be necessarily stably detected.

### SUMMARY OF THE INVENTION

It is an object of the present invention to provide an image processing method, an image processing computer program, and an apparatus provided with an image processing function which are free from the problems residing in the prior art.

According to an aspect of the present invention, an image is divided into a plurality of areas based on its content, and at least two widths substantially in horizontal direction for each divided area of the image is calculated. Using widths calculated for each divided area of the image, a plurality of width ratios are calculated. A divided area presumed to be a human image is calculated using width ratios calculated for each divided area of the image.

According to another aspect of the present invention, a program enables a computer to perform the above-mentioned operations.

According to still another aspect of the present invention, an apparatus is provided with at least one controller and/or circuit for performing the above-mentioned operations.

These and other subjects, features and advantages of the present invention will become more apparent upon a reading of the following detailed description and accompanying drawings.

### BRIEF DESCRIPTION OF THE DRAWINGS

FIG. 1 is a front view of an electronic still camera provided with a human image detecting device according to an embodiment of the invention;

FIG. 2 is a diagram showing main elements of the human image detecting device provided in a camera main body;

FIG. 3 is a diagram showing light metering spots within a viewscreen of a light measuring device;

FIG. 4 is a construction diagram of a distance measuring device;

FIG. 5 is a diagram showing an array of line sensors included in the distance measuring device;

FIG. 6 is a diagram showing distance metering spots within the viewscreen of the distance measuring device;

FIG. 7 is a diagram showing an image pickup device each formed by a pair of line sensors and a plurality of divided areas provided in the image pickup device within the viewscreen;

FIG. 8 is a diagram showing an exemplary construction in which the sensors of the distance measuring devices are replaced by area sensors;

FIG. 9 is a block diagram showing processing functions of a human figure detector;

FIG. 10 is a chart showing an example of distance images;

FIG. 11 is a diagram showing an exemplary state in which the viewscreen is divided by an area dividing operation;

FIG. 12 is a diagram showing widths calculated in a horizontally framed screen;

FIG. 13 is a diagram showing widths calculated in a vertically framed screen;

FIG. 14 is a graph showing a ratio of a head width to a trunk width obtained by examining actual human figures;

FIG. 15 is a flowchart showing a first processing procedure in the human figure detector;

FIG. 16 is a diagram showing a calculation example of the widths in the divided area;

FIG. 17 is a flowchart showing a second processing procedure in the human figure detector; and

FIG. 18 is a flowchart showing a processing procedure of AF and AF controls executed in a controller.

### DETAILED DESCRIPTION OF THE PREFERRED EMBODIMENTS OF THE PRESENT INVENTION

A photographing apparatus provided with a human image detecting device according to an embodiment of the present invention is described, taking an electronic still camera as an example.

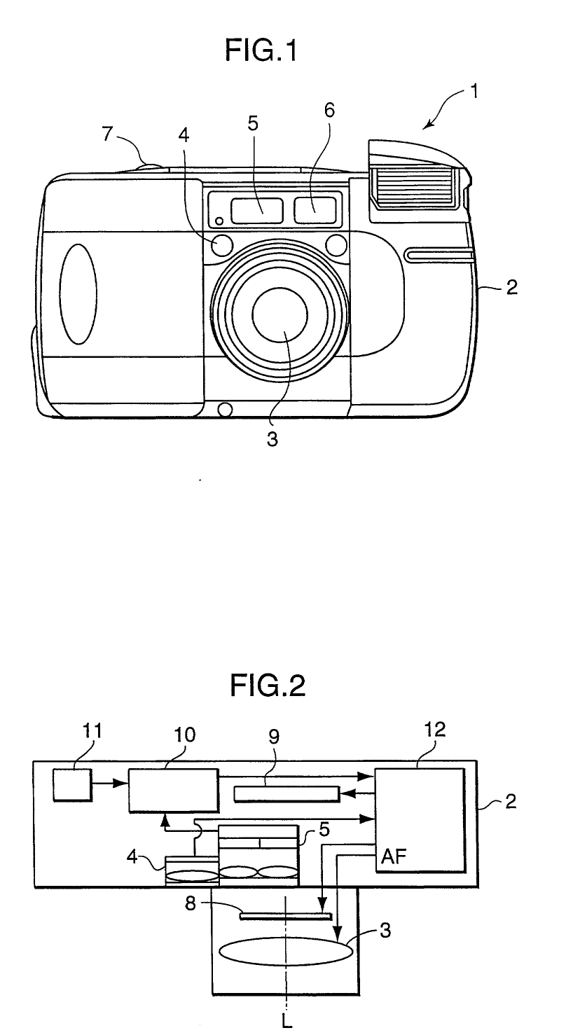

Referring to FIGS. 1 and 2, an electronic still camera 1 (hereinafter, merely “camera 1”) executes an automatic focusing control and an automatic exposure control to a subject presumed to be a human figure within a viewscreen detected by a human image detecting device to be described later.

The camera 1 includes a taking lens 3 substantially in the center of the front surface of a camera main body 2, and a light measuring device 4 for measuring a brightness of the subject is provided obliquely above the taking lens 3 to left. A distance measuring device 5 is provided above the taking lens 3, and an objective viewfinder 6 is provided at the right side of the distance measuring device 5. A shutter-start button (hereinafter, merely “start button”) 7 is provided at a suitable position at the left end of the upper surface of the camera main body 2.

As shown in FIG. 2, a lens shutter 8 formed by combining a plurality of shutter blades is provided in a lens system of the taking lens 3. An image pickup device 9, for example, comprised of a CCD (Charge-Coupled Device) area sensor is provided at a specified position on an optic axis of the taking lens 3.

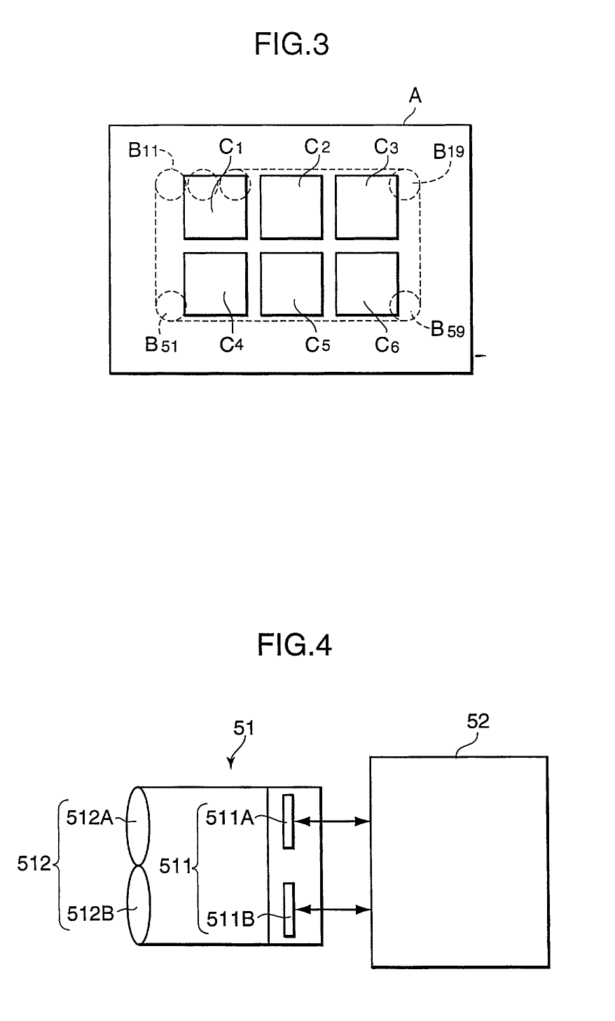

The light measuring device 4 is provided with a plurality of light detecting elements such as SPCs (Silicone Photocells) and is capable of detecting a subject brightness at a plurality of spots within the viewscreen. For example, as shown in FIG. 3, the light measuring device 4 includes six brightness detecting areas C1 to C6 in the center of a viewscreen A. These brightness detecting areas C1 to C6 are so set as to overlap distance measuring areas, including a plurality of distance measuring spots Bₙₘ to be described later, of the distance measuring device 5. Six brightness data Bv_{c1} to BV_{c6} detected by the light measuring device 4 are inputted to a controller 12 to be described later and used for an exposure control executed by the controller 12.

The distance measuring device 5 is an element of the human figure detecting device according to an embodiment of the present invention. The distance measuring device 5 is, as shown in FIG. 4, comprised of a sensor section 51 for detecting lights reflected by the subject and a calculating section 52 for calculating a distance D(m) from the camera 1 to the subject (hereinafter, “subject distance”) using an image data obtained by this sensor section 51.

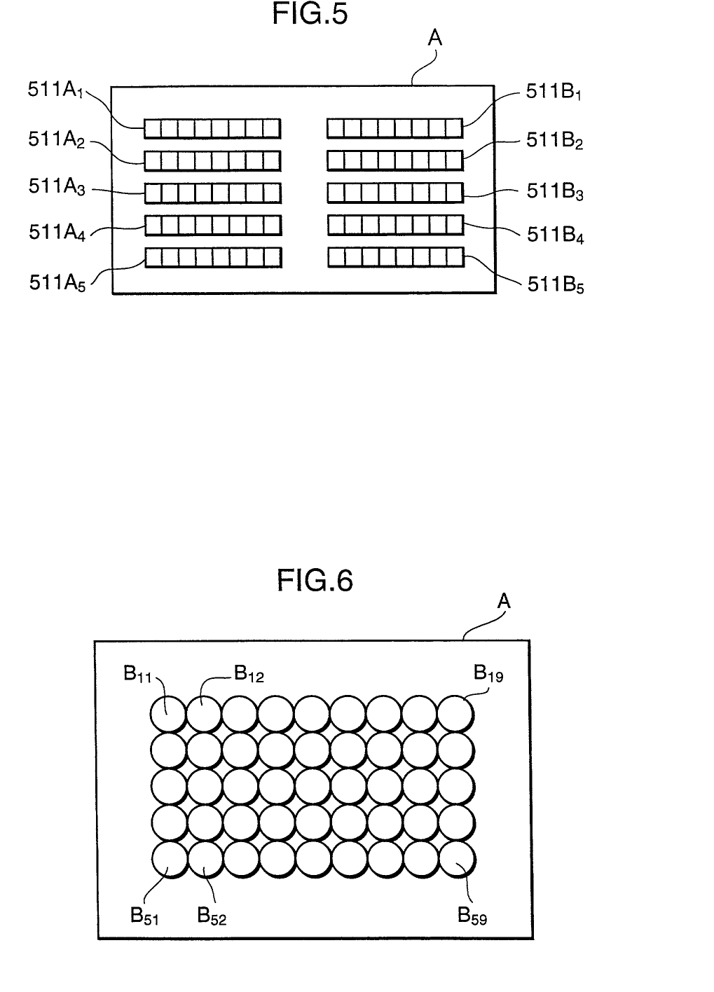

The sensor section 51 is, as shown in FIGS. 4 and 5, provided with a sensor 511 in which pairs of line sensors (511A, 511B) transversely spaced apart by a specified distance are arranged one above another at n stages (five stages in FIG. 5) and lenses 512 (512A, 512B) which are so arranged as to correspond to the respective pairs of line sensors. The lenses 512Aₙ, 512ₙ, (where n indicates the stage) focus a subject light image on the line sensors 511Aₙ, 511Bₙ, (where n indicates the stage). The line sensors 511Aₙ, 511Bₙ are, for example, CCD line sensors in which a multitude of charge-coupled elements (hereinafter, pixels) are linearly arrayed, and sense the subject light image focused by the lenses 512Aₙ, 512Bₙ for a predetermined time when sensing is instructed by the calculating section 52 and outputs an image signal (aggregate of electrical signals photoelectrically converted by the respective pixels) obtained by sensing to the calculating section 52. The calculating section 52 calculates subject distances D₁₁, D₁₂, . . . Dₙₘ at N (=n×m) distance measuring spots B₁₁, B₁₂, . . . Bₙₘ (where Bₙₘ indicates the m-th distance measuring point at the n-th stage, n=5, m=9 in this embodiment) within the viewscreen A as shown in FIG. 6 based on the principle of the trigonometric distance measurement using the image signal outputted from the sensor section 51.

The distance measurement by the distance measuring device 5 is performed when the photographer presses the start button 7 halfway.

The calculating section 52 includes a microcomputer, and calculates the subject distances Dₙ₁ to Dₙ₉ for 9 distance measuring spots Bₙ₁ to Bₙ₉ for each pair of line sensors at the respective stages. If it is assumed that the left line sensor 511A is a first image sensing device and the right line sensor 511B is a second image sensing device in FIG. 4, the subject distance Dₙ at the n-th stage is calculated based on a relative displacement between a linear image obtained by the first image sensing device and a linear image obtained by the second image sensing device. It should be noted that no detailed description is given on a calculating method of this displacement since a known method is applied.

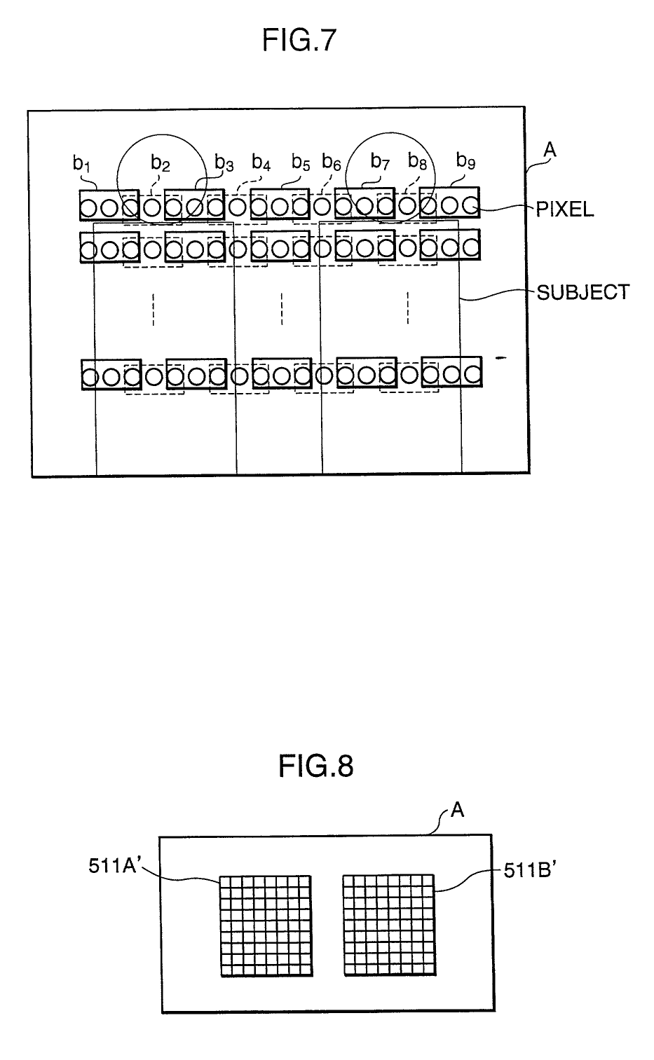

Specifically, the subject distance are calculated as follows. As shown in FIG. 7, a sensing area of each image sensing device is divided into nine partial areas b₁ to b₉ in an arrayed direction of the pixels, and relative displacements of the linear images formed by three pixel data in FIG. 7 and obtained by the first and second image sensing devices are calculated for each partial area bₘ, thereby calculating the subject distances Dₙ₁ to Dₙ₉ at the distance measuring spots Bₙ₁ to Bₙ₉ Data of 45 subject distances Dₙₘ (n=1 to 5, m=1 to 9) detected in the distance measuring device 5 are inputted to a human figure detector 10.

The number of the partial areas b is not limited to 9 and may be set at a suitable number according to the number of the distance measuring spots B in transverse direction. The number of the partial areas b may be increased in the case of increasing the number of the distance measuring spots B in transverse direction. Alternatively, subject distances D at other distance measuring spots may be calculated by interpolation using the subject distances Dₙ₁ to Dₙ₉ at the nine distance measuring spots Bₙ₁ to Bₙ₉.

Likewise, the number of the pairs of line sensors arranged at stages is not limited to 5 and may be set at a suitable number according to the number of the distance measuring spots B in vertical direction. The number of the pairs of lines sensors may be increased in the case of increasing the number of the distance measuring spots B in vertical direction. Alternatively, subject distances D at other distance measuring spots may be calculated by interpolation using the five subject distances D₁ₘ to D₅ₘ at the distance measuring spots B₁ₘ to B₅ₘ.

Although the multi-area distance measurement is applied in this embodiment by arranging a plurality of pairs of line sensors (511A, 511B) one above another in the center of the viewscreen A, the subject distance Dₙₘ may be calculated for each divided area by arranging a pair of area sensors 511A′, 511B′ in the center of viewscreen A and dividing light detecting areas of the area sensors 511A′, 511B′ into a plurality of sections as shown in FIG. 8.

Referring back to FIG. 2, the human figure detector 10 for detecting a human figure within the viewscreen A using an information on the subject distances Dₙₘ detected in the distance measuring device 5, a horizontal detector 11 for detecting an orientation of the camera main body 2 as to whether the viewscreen is vertically framed or horizontally framed, and the controller 12 for centrally controlling the photographing operation of the camera 1 are provided at suitable positions in the camera main body 2. The human image detecting device is formed by the distance measuring device 5 and the human figure detector 10; a function of an automatic focusing device is fulfilled by the distance measuring device 5 and the controller 12; and a function of an automatic exposure controlling device is fulfilled by the light measuring device 4 and the controller 12.

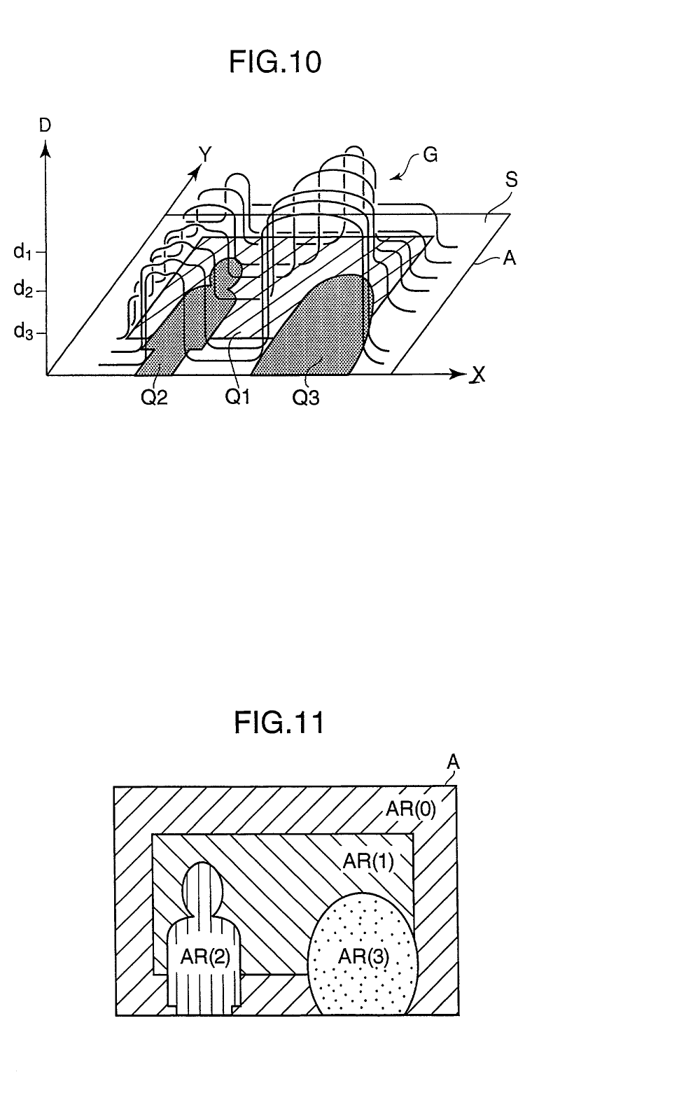

The human figure detector 10 generates a three-dimensional distance image G as shown in FIG. 10 based on n×m subject distances Dₙₘ (n=1 to 5, m=1 to 9) detected in the distance measuring device 5 and the positions of the distance measuring spots Bₙₘ within the viewscreen A corresponding to the respective subject distances Dₙₘ, and detects an area within the viewscreen A where the subject is presumed to be a human figure using the distance image G. This detection result is inputted to the controller 12. The human figure detector 10 is described in detail later.

The horizontal detector 11 detects a state where the camera main body 2 is horizontally held (state where the viewscreen is horizontally framed), and this detection information is inputted to the human figure detector 10. The horizontal detector 11 may, for example, be a switch in which an electrically conductive ball is mounted to be freely movable in a closed container having a pair of contacts on its bottom surface. When the camera 1 is horizontally held, the bottom surface of the switch is faced down. Thus, the conductive ball in the closed container moves to the bottom surface by the action of gravity to electrically connect a pair of contacts, and that the camera 1 is horizontally held is detected based on the electrically connected state of the contacts. Unless the camera 1 is horizontally held, the conductive ball does not touch the contacts since the bottom surface of the switch is not faced down. Thus, the two contacts are not electrically connected, thereby detecting that the camera 1 is not horizontally held. A horizontal detection information given by the horizontal detector 11 is used to discriminate a calculating direction of widths to be described later in the human figure detector 10.

The controller 12 performs the distance measurement (detection of a focusing position to which the focus is to be adjusted) and the exposure control when the start button 7 is pressed halfway. When the start button 7 is fully pressed, the controller 12 drives the lens shutter 8 at an aperture and a shutter speed set by the exposure control after the focus of the taking lens 3 is adjusted to the focusing position detected by the distance measurement, thereby exposing the image pickup device 9, and stores an image signal obtained by this exposure in an unillustrated storage medium after applying specified processings thereto in an unillustrated image processor. In this series of photographing processings, the controller 12 sets the focusing position using the subject distance information inputted from the human figure detector 10 and corresponding to the subject within the viewscreen A presumed to a human figure, and performs the exposure control using the luminance information corresponding to this subject. These focusing control and exposure control are described later.

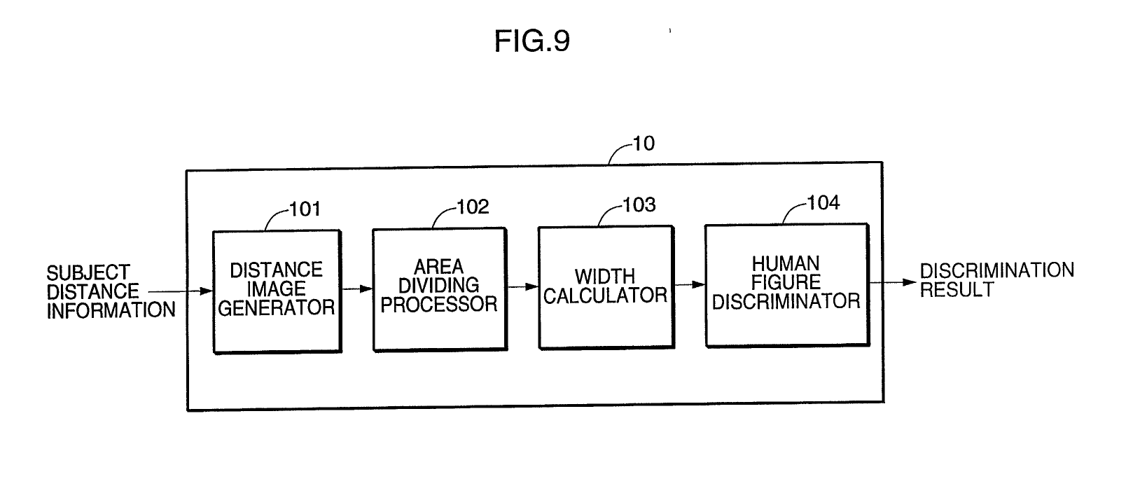

FIG. 9 is a block diagram showing the processing functions of the human figure detector 10.

The human figure detector 10 is comprised of a distance image generator 101, a area dividing processor 102, a width calculator 103 and a human figure discriminator 104. The distance image generator 101 generates the three-dimensional distance image G as shown in FIG. 10 based on n×m subject distances Dₙₘ (n=1 to 5, m=1 to 9) detected in the distance measuring device 5 and the positions of the distance measuring spots Bₙₘ within the viewscreen A corresponding to the respective subject distances Dₙₘ. If coordinate systems are set such that X-axis, Y-axis, and an axis of the subject distance D are the horizontal direction or longitudinal direction of the viewscreen A, the vertical direction of the viewscreen A and a direction normal to XY plane, the respective distance measuring spots Bₙₘ can be defined by XY coordinates (Xₙₘ, Yₙₘ) on the viewscreen A. Thus, the distance image G is generated by plotting the subject distances Dₙₘ at the respective distance measuring spots Bₙₘ (Xₙₘ, Yₙₘ)

The area dividing processor 102 divides the viewscreen A into areas included within the same subject distance ranges using the distance image G. The area dividing processor 102 divides the scale of the subject distance D at specified intervals into a plurality of ranges as shown in FIG. 10, and divides the viewscreen A into the areas having the subject distances Dₙₘ included within the respective ranges of the subject distance D.

In an example of FIG. 10, a background image S (infinitely distant subject), a most distant object image Q1, a second most distant object image Q2 and a closest object image Q3 are included in the viewscreen A. If it is assumed that an object distance Ds of an area of the background image S is almost infinite (d3<Ds) and object distances D1, D2, D3 of areas taken up by the object images Q1, Q2, Q3 are d2<D1<d3, d1<D2<d2, D3<d1, the scale of the object distance D is divided into four distance ranges of “≦d1”, “d1 to d2”, “d2 to d3” and “>d3”, and the distance measuring spots Bₙₘ corresponding to the respective subject distances Dₙₘ are divided by the areas corresponding to the distance ranges by discriminating in which of the four distance ranges the data of the object distances Dₙₘ forming the distance image G are included.

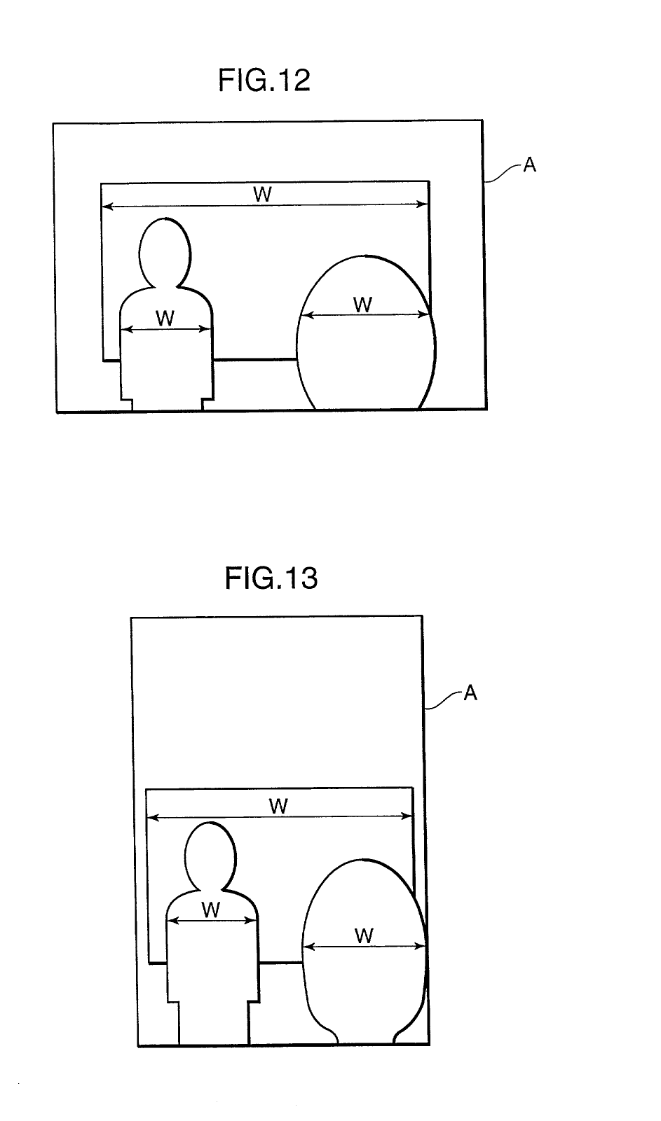

More specifically, the distance measuring spots Bₙₘ falling within the distance range “>d3” are located in an area AR(0) of the background image S; those falling within the distance range “d2 to d3” are located in an area AR(1) corresponding to the most distant object image Q1; those falling within the distance range “d1 to d2” are located in an area AR(2) corresponding to the second most distant object image Q2; and those falling within the distance range “≦d1” are located in an area AR(3) corresponding to the closest object image Q3. Thus, the viewscreen A is divided into four areas AR(0), AR(1), AR(2), AR(3) as shown in FIG. 11.

The width calculator 103 calculates widths W in horizontal direction for each divided area of the viewscreen A. A plurality of widths W are calculated at specified intervals in vertical direction for each divided area. Further, the widths W are calculated by being converted into sizes (life sizes) of the subjects. In other words, if w(pixel), p(m), D(m), f_{AF}(m) denote a width on the line sensors 511A, 511B, a pixel pitch of the line sensors 511A, 511B, a subject distance and a focal length of the optical system of the distance measuring device 5, the width W is calculated by W=w·p·D/f_{AF} (m)

The widths W are converted into the sizes of the subjects because a threshold range to be described later used to judge whether the respective divided areas AR(0) to AR(3) are areas corresponding to a human figure using the widths W are set in the sizes of the subjects. In the case that the threshold range is set in a size on the light detecting surface of the distance measuring device 5, the widths W may be set in the size (i.e., W=w) on the light detecting surface of the distance measuring device 5.

If the viewscreen A is judged to be horizontally framed based on the detection information from the horizontal detector 11, dimensions along longer sides are calculated as the widths W as shown in FIG. 12. If the viewscreen A is judged to be vertically framed based on the detection information from the horizontal detector 11, dimensions along shorter sides are calculated as the widths W as shown in FIG. 13.

The human figure discriminator 104 discriminates whether or not the subject corresponding to the divided area is a human figure using the calculated data of the widths W for each divided area (i.e., in which area of the viewscreen A a human figure is located).

In order to extract an image corresponding to a human figure from images (hereinafter, “partial images”) corresponding to objects included in an image obtained, for example, by photographing a plurality of objects, it may be thought to adopt various methods such as pattern matching as a method for discriminating whether or not each partial image is a human image. However, in this embodiment, the discrimination result is used for the AF/AE controls of the camera 1 and a high-speed processing and a relatively high discrimination precision are required. In consideration of the above, a human image is discriminated using a numerical data of a characteristic shape of the human figure, i.e., a width ratio R(Wd)=Wh/Wd of a width Wh of a face part of the head (maximum width in the head: hereinafter, “face width Wh”) to a width Wd of a trunk (width of a human figure silhouette placing both arms along the trunk, usually a maximum width in the entire human figure (hereinafter, “trunk width Wd”).

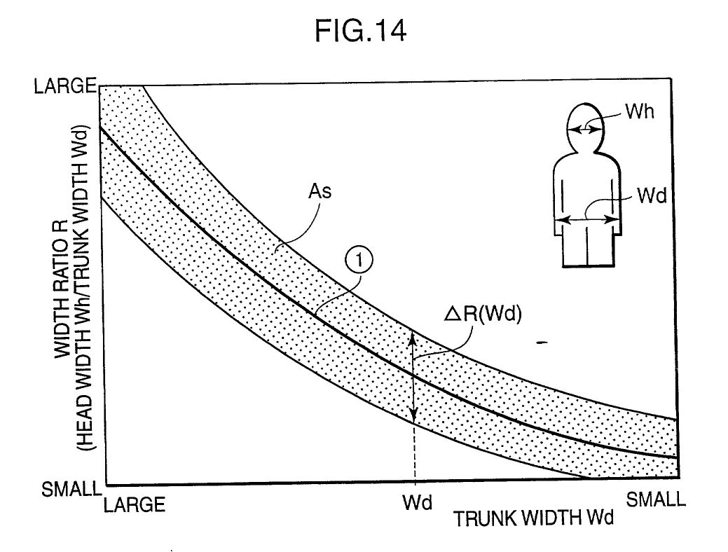

FIG. 14 shows an examination result of the width ratio of the face width to the trunk width. In FIG. 14, horizontal axis, vertical axis and a curve \mathring{1} represent the trunk width Wd (m), width ratio R of the face width Wh to the trunk width Wd, and an average width ratio Ro of the human figure.

If a plurality of widths W1, W2, . . . , Wn are calculated for a certain object silhouette and width ratios Rr(Wmax)=Wr/Wmax of other widths Wr (r=1, 2, . . . n-1) to a maximum width Wmax are calculated using the calculated widths, a width ratio Rrmin closest to the curve \mathring{1} among the width ratios Rr should be a value fairly approximate to the curve \mathring{1} in the case that this object is a human figure. On the other hand, the width ratio Rrmin would be a value fairly distanced from the curve \mathring{1} in the case that this object is something whose width varies to a very small degree like a rectangular parallelepiped. It is certain that the width ratio Rrmin calculated for this object approaches the curve \mathring{1} at least when the silhouette of this object approximates to that of the human figure.

In FIG. 14, a hatched area As including the width ratio Ro of the curve \mathring{1} is an area where the object is discriminated to be a human figure if the width ratio Rrmin calculated for this object falls within this area As. In other words, a range ΔR(Wd) of the area As at a certain trunk width Wd indicates a threshold range in discriminating whether or not a certain object is a human figure based on the width ratio Rrmin(Wd).

In this embodiment, shapes of the divided areas AR(u) (u is a number allotted to each divided area) obtained by dividing the viewscreen A based on the distance image G are used as the silhouettes of the objects, and a plurality of width ratios Rr(W1), Rr(W2), . . . Rr(Wn) converted into sizes are calculated for the respective divided areas. Thus, the human figure discriminator 104 calculates the width ratio Rrmin(Wr) closest to the curve \mathring{1} shown in FIG. 14 from these width ratios Rr(W1) to Rr(Wn), and compares it with the threshold range ΔR(Wd) used in the human figure discrimination, thereby discriminating whether or not the subject corresponding to each divided area AR(u) is a human figure.

After performing the human figure discrimination for the respective divided areas AR(u) within the viewscreen A, the human figure discriminator 104 generates a discrimination result data (for example, flags F(u) are set if the subjects Q(u) corresponding to the divided areas AR(u) are presumed to be a human figure, whereas they are not set if the subjects Q(u) are not presumed so and outputs this data to the controller 12.

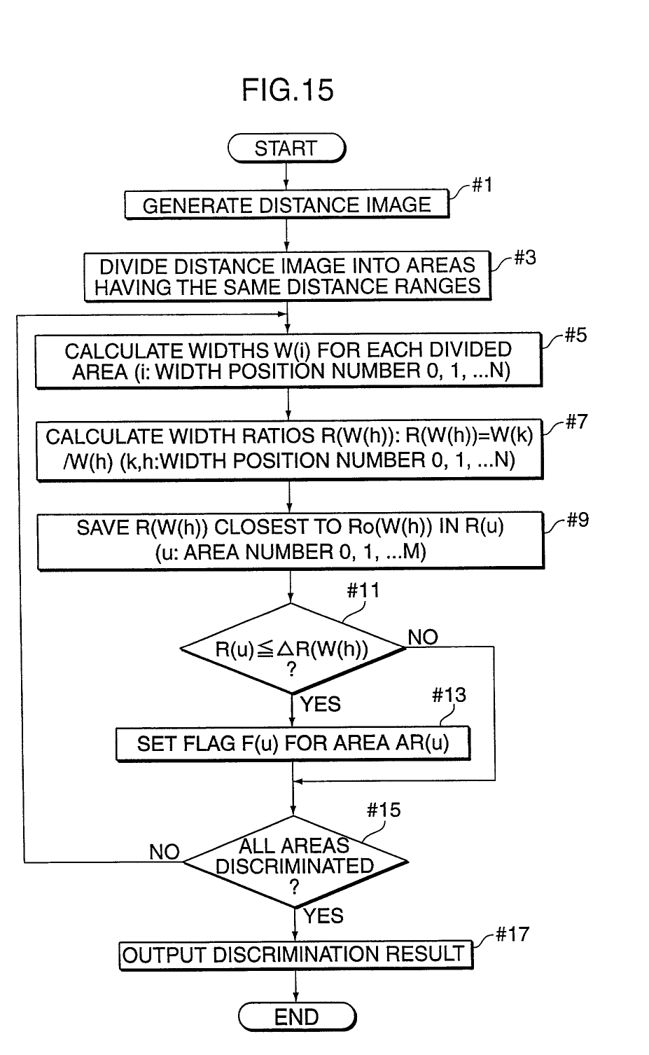

Next, a processing procedure in the human figure detector 10 is described. FIG. 15 is a flowchart showing a first processing procedure in the human figure detector.

When the information on the n×m subject distances Dₙₘ is inputted from the distance measuring device 5, the three-dimensional distance image G (see FIG. 10) is generated using the subject distances Dₙₘ and the positions of the distance measuring spots Bₙₘ within the viewscreen A corresponding to the respective subject distances Dₙₘ (Step #1). Then, the viewscreen A is divided into a plurality of divided areas AR(u) (see FIG. 11) lying within substantially the same distance ranges using the distance image G (Step #3).

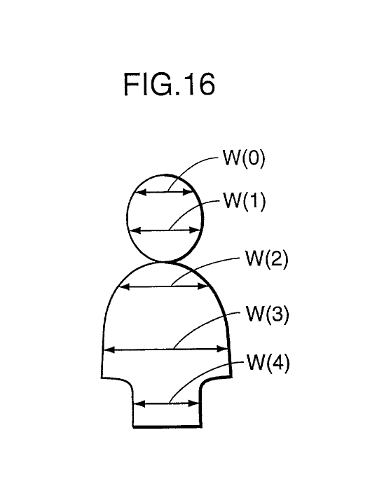

Subsequently, a plurality of widths W(i) in horizontal direction are calculated at specified intervals in vertical direction for one divided area AR(u) (Step #5). “i” in the widths W(i) denotes positions in the divided area A where the width is calculated. If, for example, 0, 1, 2, . . . are successively allotted to the width calculating positions in the divided area AR(u) from the top, W(i) denotes an i-th position from the top in the divided area AR(u). Further, the width ratios R(W(h))=W(k)/W(h) (where k≠h) are calculated using the calcualted widths W(i) (Step #7). If it is, for example, assumed that five widths W(0), W(1), . . . W(4) are obtained for the divided area AR(2) of FIG. 11 as shown in FIG. 16, a total of 20 width ratios R(W(h9) are calculated:

R(W(0))=W(1)/W(0), W(2)/W(0), W(3)/W(0), W(4)/W(0)

R(W(1))=W(0)/W(1), W(2)/W(1), W(3)/W(1), W(4)/W(1)

R(W(2))=W(0)/W(2), W(1)/W(2), W(3)/W(2), W(4)/W(2)

R(W(3))=W(0)/W(3), W(1)/W(3), W(2)/W(3), W(4)/W(3)

R(W(4))=W(0)/W(4), W(1)/W(4), W(2)/W(4), W(3)/W(4).

Subsequently, the width ratio Rmin(W(h)) closest to the average width ratio Ro(W(h)) of the human figure among the calculated width ratios R(W(h)) is calculated and is stored in an unillustrated memory as a width ratio R(u) of this divided area AR(u) (Step #9). For example, if the width ratio R(W(3))=W(1)/W(3) is closest to the width ratio Ro(W(3)) among the width ratios R(W(h)) of the divided area AR(2) in the example of FIG. 16, it is stored as R(2) in the memory.

It is then discriminated whether the width ratio R(u) falls within the threshold range ΔR(W(h)) used in judging the human figure (Step #11). If the width ratio R(u) falls within the threshold range ΔR(W(h)) (YES in Step #11), the subject corresponding to the divided area AR(u) is judged to be a human figure and the flag F(u) indicating the discrimination result is set (Step #13). On the other hand, if the width ratio R(u) lies outside the threshold range ΔR(W(h)) (NO in Step #11), the flag F(u) is not set (skip Step #13). For example, in the above example, the flag F(2) is set for the divided area AR(2) if the width ratio R(3) falls within the threshold range ΔR(W(3)), whereas the flag F(2) is not set therefor if the width ratio R(u) lies outside the threshold range ΔR(W(h)).

It is then discriminated whether the human figure discrimination has been made for all the divided areas AR(u) (Step #15). If there is any divided area AR(u) yet to be discriminated, this routine returns to Step #5 and the human figure discrimination is made for the other divided area AR(u) in a procedure similar to the aforementioned one (Steps #5 to #13). Upon completing the human figure discrimination for all the divided areas AR(u) (YES in Step #15), the discrimination result is outputted to the controller 12 (Step #17) and this discrimination routine ends.

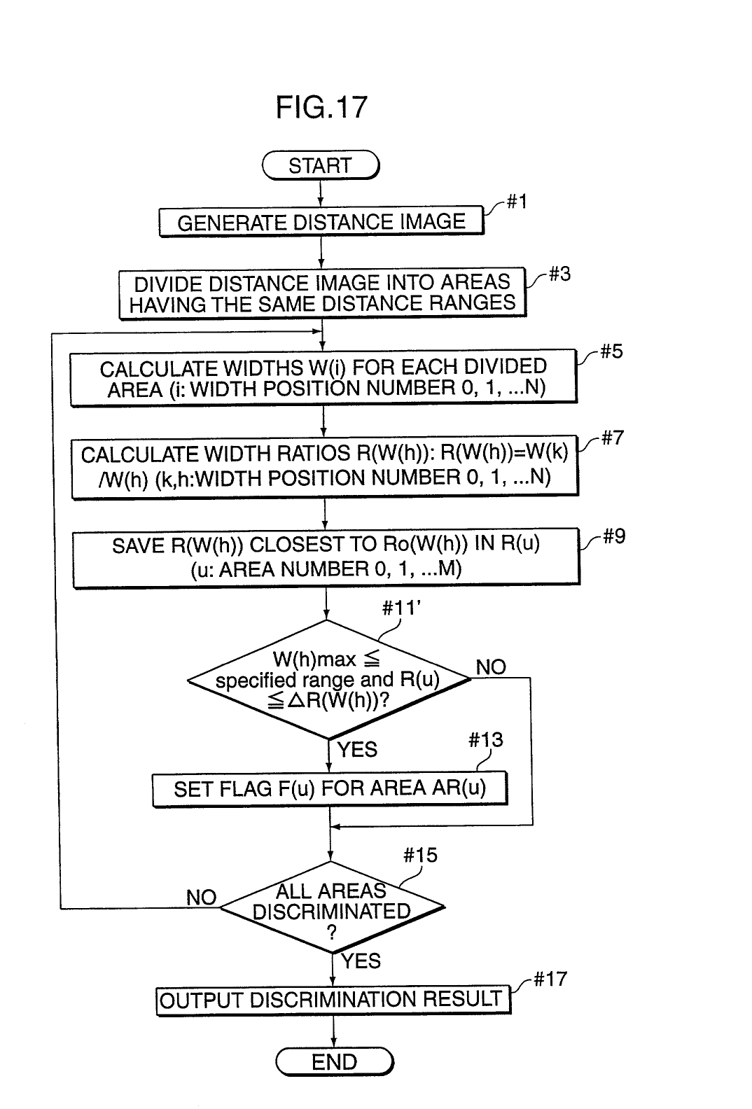

FIG. 17 is a flowchart showing a second processing procedure in the human figure detector 10.

With the embodiment, the subject is prevented from being mistakenly discriminated to be a human figure if the width ratio R(u) falls within the threshold range ΔR(W(h)) even in the case that an object is not a human figure and the width W(h) is extremely small or large.

The second human figure discrimination routine is designed to reduce the above error discrimination, and discriminate whether not only the width ratio Rmin(W(h)), but also other widths W(h) fall within a range capable of maximally excluding a possibility of detecting a nonhuman object as a human figure. Accordingly, the flowchart shown in FIG. 17 is identical to the one shown in FIG. 15 except Step #11 which is modified in the flowchart of FIG. 17.

71 Accordingly, only the modified Step #11′ is described for the flowchart of FIG. 17. In Step #11′, a maximum value W(h)max of the calculated widths W(h) (h=0, 1, . . .) is calculated, and it is discriminated whether this maximum value W(h)max falls within a specified range, capable of maximally excluding a possible of detecting a nonhuman object as a human figure, set beforehand and the width ratio R(u) falls within the threshold range ΔR(W(h)) used in the human figure discrimination. If the maximum value (h)max falls within the specified range and the width ratio R(u) falls within the threshold range ΔR(W(h)) (YES in Step #11′), the flag F(u) is set (Step #13). If either the maximum value W(h)max lies outside the specified range or the width ratio R(u) lies outside the threshold range ΔR(W(h)) (NO in Step #11′), the flag F(u) is not set (skip Step #13).

In the example of FIG. 16, the maximum value W(3) of the five widths W(0), W(1), . . . W(4) is calculated and the flag F(2) is set for the divided area AR(2) if this maximum value W(3) falls within the specified range and the width ratio R(W(3)) falls within the threshold range ΔR(W(3)), whereas it is not set for the divided area AR(2) if either the maximum value W(3) lies outside the specified range or the width ratio R(W(3)) lies outside the threshold range ΔR(W(3)).

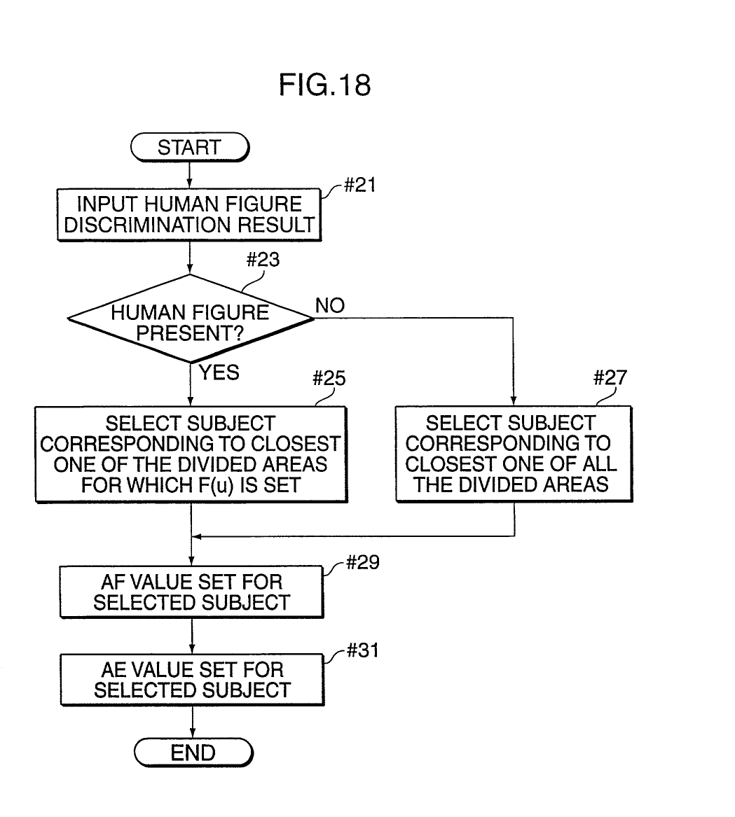

Next, the AF and AE controls in the controller 12 are described. FIG. 18 is a flowchart showing a processing procedure of the AF and AE controls executed in the controller 12. This flowchart shows the AF and AE controls as a photographing preparation when the start button 7 is pressed halfway.

When the discrimination result on the human image is inputted from the human figure detector 10 during the photographing preparation performed when the start button 7 is pressed halfway (Step #21), it is discriminated whether any human figure is present within the viewscreen A based on the discrimination result (setting information of the flags F(u)) (Step #23). If the presence of the human figure is discriminated (YES in Step #23), the subject corresponding to the closest one of the divided areas AR(u) for which the flags F(u) are set is selected (Step #25), and focus moving direction and amount, in other words, a lens position to which the taking lens should be moved to attain an in-focus condition is set using the subject distance D(u) corresponding to this subject (Step #29). Further, exposure control values (shutter speed and aperture value) are set using the brightness data Bv(u) corresponding to the selected subject (Step #31).

On the other hand, if no human figure is discriminated to be present (NO in Step #23), the subject corresponding to the closest one among all the divided areas AR(u) is selected (Step #27), and a focusing position (position of the lens for automatic focusing) is set using the subject distance D(u) corresponding to this subject (Step #29). Further, the exposure control values (shutter speed and aperture value) are set using the brightness data Bv(u) (brightness data Bv_{cn} of a light measuring area Cn corresponding to the selected divided area AR(u)) corresponding to the selected subject (Step #31). This processing performed when the human image is discriminated to be absent is designed to maximally reduce an error rate of choosing an object for the AF and AE controls by performing the AF and AE controls for the closest object among all the subjects even if the human figure detection in the human figure detector is erroneous. This is because photographing is very frequently performed while framing a human at a closest position from the camera and therefore the closest object has a high possibility of being a human. The present invention is not limited to the above processing. For example, the AF and AE controls may be performed based on an average subject distance and an average subject brightness of a plurality of objects lying within a specified range from the closest position.

In the example of FIG. 11, the focusing position is set using the subject distance D(2) corresponding to the divided area AR(2) within the viewscreen A, and the exposure control values are set using a brightness data BV_{C4} of the light measuring area C4 (see FIG. 3) corresponding to the divided area AR(2).

In the block diagrams of FIGS. 2 and 9, the respective blocks are shown according to their functions. These blocks may be constructed by individual mechanisms, circuits, etc. or a plurality of blocks may be constructed by a common mechanism or circuit. The function of a single block may also be fulfilled by cooperation of a plurality of mechanisms and circuits. Further, part or all of the blocks may be realized as functions of at least one processor including the controller 12. Furthermore, the respective blocks may be realized by a combination of the above constructions as a matter of course.

As described above, according to the foregoing embodiments, the distance image is generated using the information on a plurality of subject distances obtained by the multi-area distance measurement; a plurality of subject images lying within the viewscreen A are divided by dividing the distance image into a plurality of divided areas AR(u) based on the information on the subject distances; the width ratio R(u) is calculated for each divided area AR(u); and whether or not the object corresponding to each divided area AR(u) is a human figure is discriminated by comparing the calculated width ratio R(u) with the specified range ΔR(u) set beforehand. Thus, the human image discrimination can be made at high speed and with high precision by the relatively simple 1operations. Since the AF and AE controls are performed based on this discrimination result, focusing and exposure control for the human figure as a main subject can be suitably performed.

The information on the subject distances used to generate the distance image is obtained using the multi-area distance measuring device adopting the trigonometric distance measuring method in the foregoing embodiments. However, the electronic still cameras are provided with a function of creating viewfinder images by performing operations similar to those of the video cameras during a photographing standby period. Thus, a plurality of pieces of subject distance information may be obtained by a method for calculating the focusing position by a process for searching a position where contrast is at maximum while driving the taking lens, and setting the taking lens at the calculated focusing position. In such a case, a plurality of images are picked up at specified timings while the taking lens is moved in a specified direction, and a subject distance corresponding to an in-focus section of each photographed image is calculated based on the position of the taking lens when this image was picked, thereby obtaining the information on the subject distances used to generate the distance image.

Although the human figure detection is made using the distance image in the foregoing embodiments, it may be done using an image picked up by an image pickup device. The method for discriminating the presence of the human figure in the respective divided areas within the image can be applied if the photographed image can be divided into areas corresponding to subjects. In the case of the photographed image, the photographed image may be divided into the areas corresponding to the subjects, for example, using a color information and an information on subject brightness, and the human figure detection is made using the width ratios R for the respective divided areas.

Further, although a smooth curve \mathring{1} represents the average width ratio Ro of the human figure in the foregoing embodiment, this curve \mathring{1} may be approximated to a curve consisting of line segments and the threshold range ΔR(Wd) for the human figure discrimination may be set based on this approximated curve.

Although the electronic camera adopting the human image detecting device is described in the foregoing embodiment, the human image detecting device of this embodiment is also applicable to cameras using silver-halide films and to monitor cameras formed by video cameras. The monitor cameras can not only precisely perform the AF and AE controls, but also precisely detect human figures to be monitored.

Further, the foregoing embodiment is described with respect to the electronic camera provided with the human image detecting device. However, the user may make an electronic camera provided with a multi-area distance measuring device into the one provided with a human figure detecting function by selectively installing the program for the aforementioned human figure detection (flowchart of FIG. 15) and the specified data used to discriminate the human figure (data such as the threshold range Ro of FIG. 14) using a storage medium storing these program and data.

As described above, the image is divided into a plurality of areas based on the content thereof, and the human figure discrimination is made using two or more width ratios calculated in the divided area for each of the divided areas. Thus, the image corresponding to the human figure in the image can be securely detected. Particularly, the calculated width ratios and the specified width ratio range obtained by actually measuring ratios of the trunk width to the head width in the front-facing silhouettes of human figures are compared, and the divided area having the width ratio fallen within the specified width ratio range is discriminated to be an area of the human figure. Therefore, the human figure can be detected with a high precision.

Further, the maximum width of each divided area and the specified width range are compared and the width ratio of each divided area and the specified width ratio range are compared, and the divided area having the maximum width fallen within the specified width range and the width ratio fallen within the width ratio range is discriminated to be an area of the human figure. Thus, the human figure can be detected with an improved precision.

Furthermore, since the distance image obtained by plotting the subject distances measured by the multi-area distance measuring device at the respective distance measuring spots of the distance measuring viewscreen, the viewscreen can be precisely divided into shapes corresponding to the silhouettes of the subjects.

Further, since the horizontal direction of the distance measuring viewscreen is detected, the widthwise direction of the divided areas can be precisely judged regardless of the distance image is vertically long or horizontally long. Thus, an erroneous discrimination of the human figure caused by an erroneous judgment of the widthwise direction can be reduced.

Furthermore, the human image detecting device is applied to the photographing apparatus provided with the automatic focusing device and focusing is performed for a human figure detected by this human image detecting device. Thus, precision in automatic focusing for the human figure presumed to be a main subject can be improved.

Further, the human image detecting device is applied to the photographing apparatus provided with the multi-area light measuring device and the automatic exposure controlling device and an exposure control is performed for a human figure detected by this human image detecting device. Thus, precision in automatic exposure for the human figure presumed to be a main subject can be improved.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image processing method comprising the steps of:
an image dividing step of dividing an image into a plurality of areas based on its content;
a width calculating step of calculating at least two widths substantially in horizontal direction for each divided area of the image;
a width ratio calculating step of calculating a plurality of width ratios using widths calculated in the width calculating step for each divided area of the image; and
a human image calculating step of calculating a divided area presumed to be a human image using width ratios calculated for each divided area of the image.

2. An image processing method according to claim 1, wherein, in the human image calculating step, width ratios calculated for each divided area of the image are compared with a specified width ratio range set beforehand, and the divided area having a width ratio fallen within the width ratio range is calculated as an area of the human image.

3. An image processing method according to claim 1, wherein, in the human image calculating step, a maximum width of each divided area is compared with a specified width range set beforehand, width ratios of each divided area are compared with a specified width ratio range set beforehand, and a divided area having a maximum width fallen within the specified width range and a width ratio fallen within the specified width ratio range is calculated as an area of the human image.

4. An image processing method according to claim 3, wherein the specified width ratio range is obtained by actually measuring ratios of widths of trunks to those of heads of silhouettes of human figures viewed from front.

5. An image processing method according to claim 4, wherein the width of the trunk in a photographed image of a human figure is a maximum width in horizontal direction in the silhouette of a human figure placing both arms along the trunk.

6. A program for causing a computer to:
divide an image into a plurality of area based on its content;
calculate at least two widths substantially in horizontal direction for each divided area of the image;
calculate a plurality of width ratios using widths calculated for each divided area of the image; and
calculate a divided area presumed to be a human image using width ratios calculated for each divided area of the image.

7. A program according to claim 6, wherein the divided area presumed to be the human image is calculated by comparing width ratios calculated for each divided area of the image with a specified width ratio range set beforehand and calculating a divided area having a width ratio fallen within the width ratio range as an area of the human image.

8. A program according to claim 6, wherein the divided area presumed to be the human image is calculated by comparing a maximum width of each divided area with a specified width range set beforehand, comparing width ratios of each divided area with a specified width ratio range set beforehand, and calculating a divided area having a maximum width fallen within the specified width range and a width ratio fallen within the specified width ratio range as an area of the human image.

9. A program according to claim 8, wherein the specified width ratio range is obtained by actually measuring ratios of widths of trunks to those of heads of silhouettes of human figures viewed from front.

10. A program according to claim 9, wherein the width of the trunk in a photographed image of a human figure is a maximum width in horizontal direction in the silhouette of a human figure placing both arms along the trunk.

11. An apparatus provided with an image processing function, comprising at least one controller and/or circuit for:
dividing an image into a plurality of areas based on its content;
calculating at least two widths substantially in horizontal direction for each divided area of the image;
calculating a plurality of width ratios using widths calculated for each divided area of the image; and
calculating a divided area presumed to be a human image using width ratios calculated for each divided area of the image.

12. An apparatus according to claim 11, wherein the controller and/or circuit calculates the divided area presumed to be the human image by comparing width ratios calculated for each divided area of the image with a specified width ratio range set beforehand, and calculating a divided area having a width ratio fallen within the width ratio range as an area of the human image.

13. An apparatus according to claim 11, wherein the controller and/or circuit calculates the divided area presumed to be the human image by comparing a maximum width of each divided area with a specified width range set beforehand, comparing width ratios of each divided area with a specified width ratio range set beforehand, and calculating a divided area having a maximum width fallen within the specified width range and a width ratio fallen within the specified width ratio range as an area of the human image.

14. An apparatus according to claim 13, wherein the specified width ratio range is obtained by actually measuring ratios of widths of trunks to those of heads of silhouettes of human figures viewed from front.

15. An apparatus according to claim 14, wherein the width of the trunk in a photographed image of a human figure is a maximum width in horizontal direction in the silhouette of a human figure placing both arms along the trunk.

16. An apparatus according to claim 11, further comprising a multi-area distance measuring device having a plurality of distance measuring spots within a distance measuring viewscreen and adapted to calculate a distance to a subject at each distance measuring spot, wherein the image is a distance image formed by plotting subject distances measured by the multi-area distance measuring device at respective distance measuring spots within the distance measuring viewscreen.

17. An apparatus according to claim 16, wherein the controller and/or circuit detects a horizontal direction of the distance measuring viewscreen, and determines widths of the distance image in the horizontal direction based on a horizontal direction detection result.

18. An apparatus according to claim 11, further comprising a photographing device and an automatic focusing device for automatically adjusting a focus of the photographing device, wherein the automatic focusing device adjusts the focus to a subject corresponding to the detected divided area presumed to be the human figure.

19. An apparatus according to claim 18, further comprising a multi-area light measuring device and an automatic exposure controlling device, wherein the automatic exposure controlling device performs an exposure control using a subject brightness of a subject corresponding to the divided area presumed to be the human image which area is detected by the human image detecting device out of subject brightnesses detected by the multi-area light measuring device.
